(19) United States
(12) Patent Application Publication
(10) Pub. No.: US 2008/0277383 A1
(43) Pub. Date: Nov. 13, 2008

(54) APPARATUS FOR REMOVING DEBRIS FROM THE CUTTING GAP OF A WORK PIECE ON A WIRE ELECTRONIC DISCHARGE MACHINE AND METHOD THEREFOR

(76) Inventors: Michael Sandlin, Chandler, AZ (US); Frank Froncillo, Maricopa, AZ (US)

Correspondence Address: WEISS & MOY PC, 4204 NORTH BROWN AVENUE, SCOTTSDALE, AZ, 85251, US

(21) Appl. No.: 11/747,404

(22) Filed: May 11, 2007

(51) Int. Cl. B23H 1/04

(52) U.S. Cl. 219/69.12

(57) ABSTRACT

A debris removal system for a wire electronic discharge machining (WEDM) apparatus has a fluid source. A pressurization device is coupled to the fluid source to pressurize a fluid from the fluid source. At least one fluid delivery nozzle is coupled to the pressurize device. The at least one fluid delivery nozzle is positioned behind a wire electrode of the WEDM apparatus and approximately perpendicular to the wire electrode to inject the pressurized fluid directly into an active cutting area between the wire and work piece.

### BACKGROUND OF INVENTION

1. Field of Invention

The present invention relates to electronic discharge machining (EDM), and more particularly to an apparatus and method for improving the removal of debris from the cutting gap of a work piece during wire electronic discharge machining (WEDM) to increase cutting rates and efficiency during WEDM.

2. Description of Related Art

Electrical discharge machining (EDM) is a method used to cut hard metals or metals that are difficult to machine with traditional techniques. EDM only works with materials that are electrically conductive. During the EDM process, material from a metal work piece is removed by using a series of rapidly recurring electric arcing discharges between a pair of electrodes on the EDM cutting tool. The metal work piece is positioned between the electrodes. The EDM cutting tool is guided along a desired path very close to the metal work piece; however the electrodes do not touch the piece. Consecutive sparks produce a series of micro-craters on the metal work piece and remove material along the cutting path by melting and vaporizing the metal work piece.

One type of EDM machine is a wire EDM machine. In wire electrical discharge machining (WEDM), a thin single-strand of metal wire is the active electrode used to generate the sparks that erode the material. The metal wire is fed from a spool and held between upper and lower guides. The guides move in the x-y plane thereby giving the wire-cut EDM the ability to be programmed to cut intricate shapes.

In the wire EDM machine, dielectric fluid is used to wash away particulates that are generated at the cut interface in the cut gap during the EDM process. The dielectric fluid is delivered via conduits housed in the upper and lower EDM heads. The heads are positioned above and below the highest and lowest points of the metal work piece so that the EDM heads do not collide with the metal work piece as the wire traverses the cut. In work pieces with non-parallel upper and lower surfaces the entry and exit points of the wire in the metal work piece are necessarily located at some distance from the upper and lower heads, and the fluid coming from the EDM heads is not effectively forced into the cutting gap. In such cases the penetration of high velocity fluid is limited to the outermost portion of the cutting gap. In general, poor fluid penetration leads to ineffective debris removal at the cut interface, in the cut gap. Ineffective debris removal leads to sub-optimal material removal rates (MRR). Presently, conventional EDM machines do not provide for effective high-velocity fluid penetration on work-pieces with non-parallel upper and lower surfaces, such as round or cylindrical work-pieces positioned in the EDM with the radial direction in the vertical plane.

Therefore, it would be desirable to provide an apparatus and method that overcomes the above problem. The apparatus and method must be able to facilitate the removal of debris from the cutting gap, at the cut interface during the WEDM process to increase cutting efficiency during WEDM.

### SUMMARY OF INVENTION

In accordance with one embodiment of the present invention, a debris removal system for a wire electronic discharge machining (WEDM) apparatus is disclosed. The debris removal system has a fluid source. A pressurization device is coupled to the fluid source to pressurize a fluid from the fluid source. At least one fluid delivery nozzle is coupled to the pressurization device. The at least one fluid delivery nozzle is positioned behind a wire electrode of the WEDM apparatus and is used to inject the pressurized fluid directly into an active cutting area, which is between the wire and the work piece, from behind the wire electrode.

In accordance with one embodiment of the present invention, a debris removal system for a wire electronic discharge machining (WEDM) apparatus is disclosed. The debris removal system has a fluid source. A pressurization device is coupled to the fluid source to pressurize a fluid from the fluid source. At least one fluid delivery nozzle is coupled to the pressurization device. The at least one fluid delivery nozzle is positioned behind a wire electrode of the WEDM apparatus to inject the pressurized fluid directly into an active cutting area from behind the wire electrode. The at least one fluid delivery nozzle is adjustable to deliver pressurized fluid in one of a direction perpendicular to the wire electrode or at an arbitrary angle to the wire electrode along a cut line.

The foregoing and other objects, features, and advantages of the invention will be apparent from the following, more particular, description of the preferred embodiments of the invention, as illustrated in the accompanying drawing.

### BRIEF DESCRIPTION OF DRAWINGS

The present invention will become more fully understood from the detailed description and the accompanying drawings, wherein:

FIG. 1 is a prior art WEDM apparatus.

FIG. 2 is a WEDM apparatus with the debris removal system of the present invention.

FIG. 2A is a magnified side view of the work piece showing the wire electrode and the nozzle of the debris removal system.

FIG. 2B is a magnified side view of the work piece showing the fluid dispersal through the cut gap.

FIG. 3 is a simplified block diagram of the debris removal system of the present invention.

FIG. 4 is a side view of the nozzle used in the debris removal system of the present invention.

FIG. 5 is a cross-sectional side view of the nozzle used in the debris removal system of the present invention.

FIG. 6 is a front view of the nozzle used in the debris removal system of the present invention.

### DETAILED DESCRIPTION

Presently there is insufficient penetration of high-velocity fluid during WEDM cutting of work pieces with non-parallel upper and lower surfaces. This is especially problematic with cylindrical work pieces when cutting in the plane of the radial direction. Poor fluid penetration leads to poor debris removal which leads to reduced material removal rates (MRR). Conventional WEDM equipment does not provide for effective high-velocity fluid penetration into the cutting gap of work pieces with non-parallel upper and lower surfaces, such as round or cylindrical work-pieces oriented with the radial direction in the same plane as the wire cut.

The invention provides an apparatus and method for delivering high-velocity dielectric fluid into the active cutting region of a discharging wire of a WEDM. The present invention is particularly beneficial while cutting work piece geometries that are not amenable to producing a sealed flushing condition with the upper and lower flushing heads of a conventional WEDM.

In accordance with one embodiment of the present invention, an apparatus and method are disclosed for delivering high-velocity dielectric fluid into the active cutting region of the discharging wire of a WEDM while cutting of cylindrical work-pieces in the radial direction with the wire oriented parallel to the plane of the cylinder's flat surface. By effectively providing a high-velocity fluid into the active cutting region, the debris removal rate (DRR) increases at the cut interface. This stabilizes and accelerates the MRR. Increased MRRs lead to higher manufacturing throughputs per machine thereby creating an economic benefit.

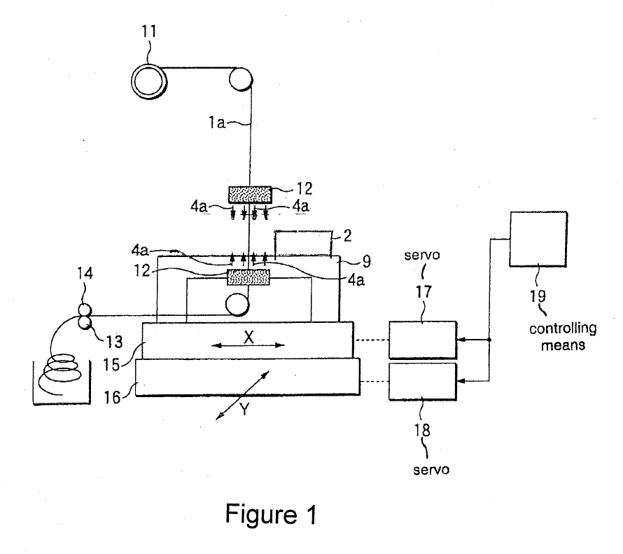

Referring to FIG. 1, a simplified block diagram of a prior art wire electrical discharge machining (WEDM) apparatus is shown. The WEDM apparatus has a wire electrode 1a. One end of the wire electrode is coupled to a roller 11. A second end of the wire 1a is placed between a pair of rollers 13 and 14.

The work piece 2 is placed on a plate 9. An X-table 15 is coupled to the plate 9. The X-table 15 is used for moving the plate 9 and hence the work piece 2 in a horizontal direction (in the X direction). A Y-table 16 is coupled to the X-table 15 and the plate 9. The Y-table 16 is used for moving the work piece 2 in a horizontal direction (in the Y direction). The X-table 15 is coupled to an X-axis servo unit 17. The X-axis servo unit 17 is used for controlling a drive motor (not shown) for moving the X table 15. Similarly, the Y-table 16 is coupled to a Y-axis servo unit 18. The Y-axis servo unit 18 is used for controlling a drive motor (not shown) for moving the Y table 16. The X-axis servo unit 17 and the Y-axis servo unit 18 are coupled to a control unit 19. The control unit 19 is used to send control signals to the X-axis servo unit 17 and the Y-axis servo unit 18.

The wire electrode 1a is moved by the movement of the rollers 13 and 14. Machining electric power is supplied across the gap between the wire electrode 1a and the work piece 2 by a machining-electric-power supplying section (not shown) while the wire electrode 1a is driving. Machining of the work piece 2 is performed by moving the wire electrode 1a and the work piece 2 by means of the X table 15 and the Y table 16.

Fluid conduits 12 are positioned above and below the work piece 2. The fluid conduits 12 dispense a fluid 4a to wash away particulates during the WEDM process. As stated above, a problem with the fluid conduits 12 is the fluid conduits 12 must be located above and below the highest and lowest points of the metal work piece so that the EDM heads do not collide with the metal work piece as the wire electrode 1a traverses the cut. Because the entry and exit points of the wire electrode 1a in the metal work piece are necessarily located at some distance from the upper and lower heads when cutting workpieces with non-parallel upper and lower surfaces, the fluid coming from the fluid conduits 14 is not effectively forced into the cutting gap, and the penetration of high velocity fluid is limited to the outermost portion of the cutting gap.

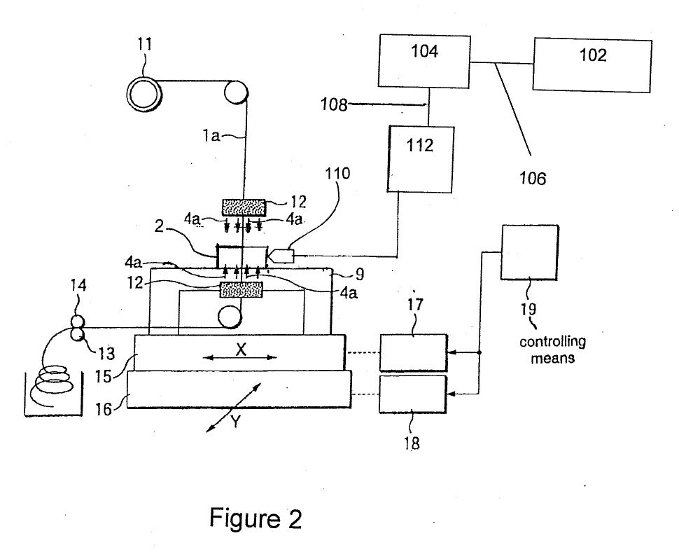

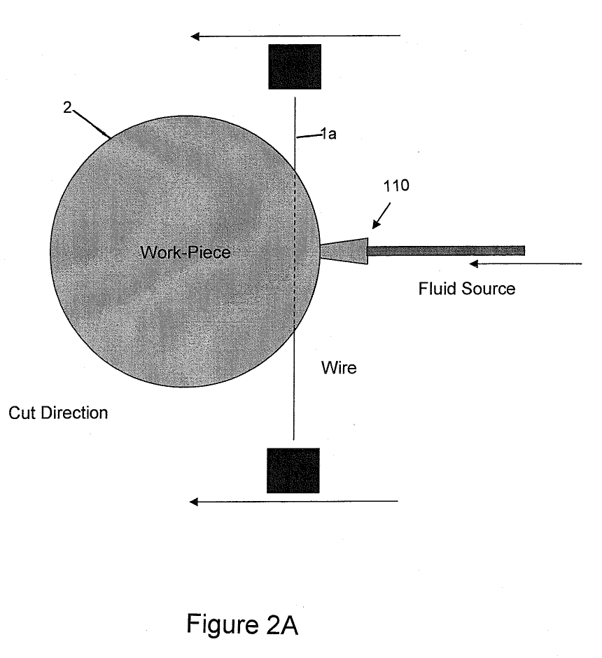

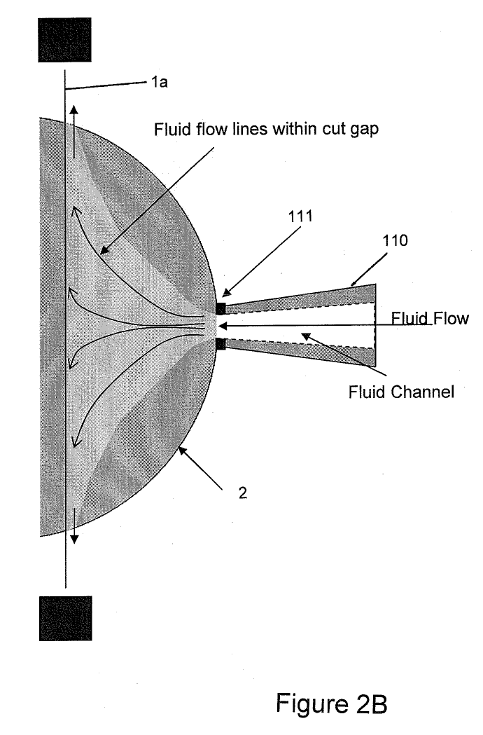

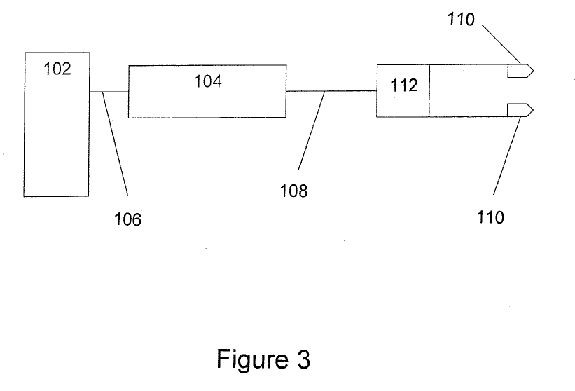

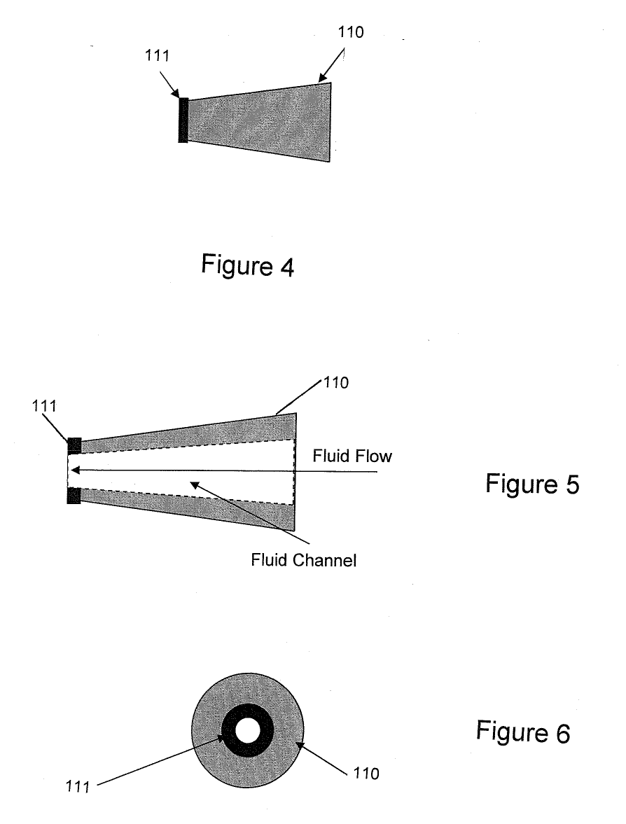

Referring to FIGS. 2-6, an apparatus 100 to improve the DRR for a WEDM apparatus is shown. The apparatus 100 is a high-velocity fluid delivery system that injects fluid into the back or side of the work piece 2. The fluid is injected into the back of the cut directly into the active cutting region of the work piece 2, which lies between the wire and the workpiece. By directly injecting high-velocity fluid into the active cutting region, the DRR increases at the cut interface, which stabilizes and accelerates the MRR. Increased MRRs lead to higher manufacturing throughputs per machine thereby creating an economic benefit.

The apparatus 100 uses a fluid supply 102. The fluid supply 102 will generally be a dielectric fluid supply such as deionized water source, a flash point kerosene supply, or any other fluid supply that stabilizes the temperature of the work piece, along with flushing any eroded particles from the immediate work area. The fluid supply 102 may be from an outside source. Alternatively, the fluid source 102 may be an existing fluid source from the WEDM apparatus using the apparatus 100.

The fluid supply 102 is coupled to a pressurization device 104. The fluid supply 102 may be directly coupled to the pressurization device 104. Alternatively, a conduit 106 may be used to couple the fluid supply 102 to the pressurize device 104. In general, a fluid tight seal is formed between the fluid supply 102 and the pressurize device 104. The fluid tight seal may be formed in a plurality of different manners such as threaded connections, fluidproof caulking, fluid tight clamps, washer assemblies, rubber gaskets, and the like. The above is given as examples and should not be seen as to limit the scope of the present invention.

The pressurization device 104 will take the fluid from the fluid source 102 and pressurizes the fluid. The pressurized fluid is then delivered to one or more fluid delivery nozzles 110 via conduit 108. A fluid tight seal is generally formed between the pressurize device 104 and the conduit 108. The conduit 108 is generally coupled to the plate 9 of the WEDM apparatus and behind the work piece. The conduit 108 may be made of any material that is able to hold and deliver the pressurized fluid. In accordance with one embodiment of the present invention, a metal piping is used as the conduit 108. However, this should not be seen as to limit the scope of the present invention.

As stated above, one or more fluid delivery nozzles 110 are coupled to the conduit 108. A fluid tight seal is generally formed between the fluid delivery nozzles 110 and the conduit 108. The one or more fluid delivery nozzles 110 are positioned behind and approximately perpendicular to the wire electrode 1a. This position will allow the one or more fluid delivery nozzles 110 to inject the pressurized fluid directly into active cutting area in the cutting gap in the back of the cut, behind the wire electrode 1a. The one or more fluid delivery nozzles 110 will inject high-velocity fluid into the entire active cutting region, regardless of work piece geometry, and as a result the minimum DRR increases at the cut interface.

In FIG. 2B, the fluid flow lines within the cut gap are shown. As may be seen, the fluid is injected into the back/side of the work piece 2 directly into the active cutting region. The fluid flows out of the top and bottom of the work piece 2 thereby increasing the DDR. This increased DRR stabilizes and accelerates the MRR. Increased MRRs lead to higher manufacturing throughputs per machine thereby creating an economic benefit. The direction of fluid flow is reversed from prior art. In prior art fluid flows away from the top and bottom heads and out the back of the part, whereas in the present invention, the fluid flows towards the top and bottom heads from the back of the part. Since fluid is flowing from the back of the part, toward the cut interface, fluid is more effectively forced against the cut interface, along the whole cut interface, where all of the debris is being generated, which allows for more effective debris removal.

The fluid delivery nozzles 110 may be adjustable in order to deliver fluid that is moving in the direction perpendicular to the wire or at an arbitrary angle to the wire along the cut line. The fluid delivery nozzles 110 may have a rubber gasket 111 located at the tip of the fluid delivery nozzles 110. The rubber gasket 111 of the fluid delivery nozzles 110 may contact the back of work piece 2 in a location suitable to inject fluid into the cutting gap formed by the wire. The rubber gasket 111 will form a better seal between the nozzle 110 and the work piece 2 in order to directly inject the high-velocity fluid into the active cutting region. In accordance with one embodiment of the present invention, the rubber gasket is an O-ring seal.

The one or more fluid delivery nozzles 110 can vary in size and shape to accommodate fluid injection into a single cut gap, or many cut gaps of a work piece. The one or more fluid delivery nozzles 110 can vary in shape and size to accommodate fluid injection into many different work piece geometries. The one or more fluid delivery nozzles 110 can vary in size and shape to modulate pressure and volume in such a way as to optimize DRRs. The fluid delivery nozzles 110 are adjustable so that the fluid delivery nozzles 110 can deliver fluid that is moving in the direction perpendicular to the wire or at an arbitrary angle to the wire along the cut line.

A control unit 112 may be coupled between the fluid delivery nozzles 110 and the conduit 108. The control unit 112 may be used to modulate pressure and volume in the fluid delivery nozzles 110. The control unit 112 may control the fluid delivery nozzles 110 in other ways without departing from the spirit and scope of the present invention.

The apparatus 100 can possibly lead to MRRs that are several times faster than MRRs currently achievable without the use of the apparatus 100. The increased flushing provided by the apparatus 100 will facilitate increases in the discharge frequency, discharge power, discharge current, pulse duration, and linear cutting velocity of the WEDM apparatus and decreases in the time delay in ignition without substantially increasing the frequency of wire electrode breaks. This increase in cutting speed will allow one significantly increase factory throughput without substantial additional capital investment.

The flushing effectiveness of the apparatus 100 is not dependent on the proximity of the fluid delivery nozzles 110 to the work piece 2. The fluid delivery nozzles 110 may be move above or below the work piece 2 and will still obtain very good flushing along the cut line. This allows one to maintain excellent flushing on work pieces 2 that vary in height along the cut line, such as cylinders, trapezoids, parts with steps, and other non-rectangular parts.

Further, since apparatus 100 is not coupled to any moving parts, a reliable static contact seal is formed which allows one to inject fluid at higher pressure, volume, and flow-rate than dynamic non-contact fluid injection. Because of this, one can more effectively remove debris from thicker parts.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A debris removal system for a wire electronic discharge machining (WEDM) apparatus comprising:
a fluid source;
a pressurization device coupled to the fluid source to pressurize a fluid from the fluid source; and
at least one fluid delivery nozzle coupled to the pressurization device, the at least one fluid delivery nozzle positioned behind a wire electrode of the WEDM apparatus and approximately perpendicular to the wire electrode to inject the pressurized fluid directly into an active cutting area between the wire and work piece.

2. A debris removal system for a wire electronic discharge machining (WEDM) apparatus in accordance with claim 1 wherein the at least one fluid delivery nozzle is adjustable to deliver pressurized fluid in one of a direction perpendicular to the wire electrode or at an arbitrary angle to the wire electrode along a cut line.

3. A debris removal system for a wire electronic discharge machining (WEDM) apparatus in accordance with claim 1 further comprising a control unit coupled to the at least one fluid delivery nozzle to control operation of the at least one fluid delivery nozzle.

4. A debris removal system for a wire electronic discharge machining (WEDM) apparatus in accordance with claim 1 wherein the at least one fluid delivery nozzle can vary in shape and size to accommodate fluid injection into a plurality of work piece geometries.

5. A debris removal system for a wire electronic discharge machining (WEDM) apparatus in accordance with claim 1 wherein the at least one fluid delivery nozzle can vary in size and shape to modulate pressure and volume to optimize DRRs.

6. A debris removal system for a wire electronic discharge machining (WEDM) apparatus in accordance with claim 1 wherein the at least one fluid delivery nozzle delivers pressurized fluid into the active cutting region of the wire electrode while cutting of the work piece in a radial direction with the wire electrode oriented parallel to the work piece.

7. A debris removal system for a wire electronic discharge machining (WEDM) apparatus in accordance with claim 1 wherein the at least one fluid delivery nozzle delivers pressurized fluid into the active cutting region of the wire electrode while cutting of cylindrical work-pieces in a radial direction with the wire electrode oriented parallel to the plane of the cylinder's flat surface.

8. A debris removal system for a wire electronic discharge machining (WEDM) apparatus in accordance with claim 1 further comprising a rubber gasket coupled to an end of the at least one fluid delivery nozzle to form a seal between the at least one nozzle and the work piece to directly inject the high-velocity fluid into the active cutting region.

9. A debris removal system for a wire electronic discharge machining (WEDM) apparatus comprising:
a fluid, source;
a pressurization device coupled to the fluid source to pressurize a fluid from the fluid source; and
at least one fluid delivery nozzle coupled to the pressurize device, the at least one fluid delivery nozzle positioned behind a wire electrode of the WEDM apparatus to inject the pressurized fluid directly into the active cutting area from behind the wire electrode, the at least one fluid delivery nozzle is adjustable to deliver pressurized fluid in one of a direction perpendicular to the wire electrode or at an arbitrary angle to the wire electrode along a cut line.

10. A debris removal system for a wire electronic discharge machining (WEDM) apparatus in accordance with claim 9 further comprising a control unit coupled to the at least one fluid delivery nozzle to control operation of the at least one fluid delivery nozzle.

11. A debris removal system for a wire electronic discharge machining (WEDM) apparatus in accordance with claim 9 wherein the at least one fluid delivery nozzle can modulate pressure and volume to optimize DRRs.

12. A debris removal system for a wire electronic discharge machining (WEDM) apparatus in accordance with claim 9 wherein the at least one fluid delivery nozzle delivers pressurized fluid into the active cutting region of the wire electrode while cutting of the work piece in a radial direction with the wire electrode oriented parallel to the work piece.

13. A debris removal system for a wire electronic discharge machining (WEDM) apparatus in accordance with claim 9 further comprising a rubber gasket coupled to an end of the at least one fluid delivery nozzle to form a seal between the at least one nozzle and the work piece to directly inject the high-velocity fluid into the active cutting region.

14. A method of cutting a work piece with a wire electronic discharge machining (WEDM) apparatus comprising:
providing a fluid source;
providing a pressurize device coupled to the fluid source to pressurize a fluid from the fluid source; and
providing at least one fluid delivery nozzle coupled to the pressurize device, the at least one fluid delivery nozzle positioned behind a wire electrode of the WEDM; and
injecting the pressurized fluid directly into an active cutting area from behind the wire electrode.

15. The method of claim 14 further comprising injecting the pressurized fluid into the active cutting region of the wire electrode while cutting of the work piece in a radial direction with the wire electrode oriented parallel to the work piece.

16. The method of claim 14 further comprising providing the at least one fluid delivery nozzle that is adjustable to deliver pressurized fluid in one of a direction perpendicular to the wire electrode or at an arbitrary angle to the wire electrode along a cut line.

17. The method of claim 14 further comprising providing a control unit coupled to the at least one fluid delivery nozzle to control operation of the at least one fluid delivery nozzle.

18. The method of claim 14 further comprising modulating a pressure and volume of the at least one fluid delivery nozzle to optimize DRRs.

19. The method of claim 14 further comprising delivering the pressurized fluid into the active cutting region of the wire electrode while cutting of the work piece in a radial direction with the wire electrode oriented parallel to the work piece.
